(19) United States
(12) Patent Application Publication
(10) Pub. No.: US 2016/0156020 A1
(43) Pub. Date: Jun. 2, 2016

(54) METHOD FOR MANUFACTURING CATHODE ELECTRODE MATERIALS

(71) Applicant: HITACHI METALS, LTD., Tokyo (JP)

(72) Inventors: Hisato TOKORO, Tokyo (JP); Akira GUNJI, Tokyo (JP); Tatsuya TOYAMA, Tokyo (JP); Xiaoliang FENG, Tokyo (JP); Mitsuru KOBAYASHI, Tokyo (JP); Shin TAKAHASHI, Tokyo (JP); Shuichi TAKANO, Tokyo (JP); Takashi NAKABAYASHI, Tokyo (JP); Sho FURUTSUKI, Tokyo (JP)

(73) Assignee: HITACHI METALS, LTD., Tokyo (JP)

(21) Appl. No.: 14/937,548

(22) Filed: Nov. 10, 2015

(30) Foreign Application Priority Data
Nov. 27, 2014 (JP) 2014-239608
Jun. 5, 2015 (JP) 2015-114400

(51) Int. Cl. H01M 4/04; C01G 53/00; H01M 4/505; H01M 4/48; H01M 4/525; H01M 4/485

(52) U.S. Cl. CPC H01M 4/0471; H01M 4/525; H01M 4/485; H01M 4/505; H01M 4/483; C01G 53/006; H01M 2004/028

(57) ABSTRACT

Provided is a method for manufacturing a cathode electrode material, including the step of performing calcination of a mixture of lithium carbonate and a compound containing Ni, and capable of mass-producing a cathode electrode material including a lithium composite oxide with high Ni concentration industrially. The manufacturing method includes a mixture step of mixing lithium carbonate and a compound including Ni, and a calcination step of performing calcination of a mixture obtained in the mixture step under oxidizing atmosphere to obtain a lithium composite compound with high Ni concentration. The calcination step includes: a first heat treatment step to obtain a first precursor; a second heat treatment step of performing heat treatment of the first precursor to obtain a second precursor; and a third heat treatment step of performing heat treatment of the second precursor to obtain the lithium composite compound. In the second and the third heat treatment steps, oxidizing atmosphere has oxygen concentration of 80% or more.

### CLAIM OF PRIORITY

The present application claims priority from Japanese patent application JP 2015-114400 filed on Jun. 5, 2015, the content of which is hereby incorporated by reference into this application.

### BACKGROUND

1. Technical Field

The present invention relates to a method for manufacturing a cathode electrode material used for a cathode of a lithium-ion secondary battery.

2. Background Art

Lithium-ion secondary batteries are available as one type of non-aqueous secondary batteries including non-aqueous electrolyte that conducts electricity between electrodes. In a lithium-ion secondary battery, lithium ions conduct electricity between electrodes during charge/discharge reaction, and as compared with other secondary batteries, such as a nickel-hydrogen storage cell and a nickel-cadmium storage cell, a lithium-ion secondary battery has features of high energy density and a small memory effect. Such lithium-ion secondary batteries therefore have expanded in the application from a small-sized power source used for a portable electronic device, home appliance or the like to a fixed power supply used as an electrical power storage device, an uninterruptible power source or a power leveling device and a medium or large-sized power source used for driving of ship, railway, hybrid vehicles and electric vehicles.

Especially when a lithium-ion secondary battery is used as a medium or large-sized power source, the battery is required to have higher energy density. To realize high energy density of a battery, its cathode and anode have to have higher energy density, and so materials used for the cathode and the anode have to have higher capacity. Known cathode electrode materials having high charge/discharge capacity include the lithium composite compound powder represented by the chemical formula of LiM′O₂ (M′ denotes elements such as Ni, Co, and Mn) having an α-NaFeO₂ type layered structure. Since this cathode electrode material tends to have higher capacity especially with higher ratio of Ni, such a material is expected to be a cathode electrode material to realize a higher-energy battery.

As one of these cathode electrode materials, lithium-containing component powder represented as LiₐNi_{b}M1_{c}M2_{d}(O)₂(SO₄)X and its manufacturing method are disclosed (see the following Patent Document 1). The invention described in Patent Document 1 aims to provide lithium mixed metal oxide in which secondary particles are not broken or not comminuted during the process to manufacture the battery (cathode). To fulfill the aim, the pulverulent material after compression at the pressure of 200 MPa has a difference in a D10 value from that of the initial pulverulent material within 1.0 μm, which is measured according to ASTM B 822.

The pulverulent lithium-containing compound described in Patent Document 1 is manufactured by the process including the steps of preparing a co-precipitated nickel-containing precursor having predetermined porosity, and mixing the nickel-containing precursor with a lithium-containing component to produce a precursor mixture. Exemplary lithium-containing component described includes lithium carbonate, lithium hydroxide, lithium hydroxide monohydrate, lithium oxide, lithium nitrate, or mixtures thereof. The process further includes the steps of heating the thus obtained precursor mixture by multistage heating to 200 to 1000° C. with the use of a CO₂-free (0.5 ppm or less of CO₂) oxygen-containing carrier gas to produce a pulverulent product, and of deagglomerating the powder by means of ultrasound and sieving of the deagglomerated powder.

According to Patent Document 1, the temperature hold stages and associated controlled reaction during the manufacturing process can yield a product free from secondary particle agglomerates that are strongly sintered together. Thereby, milling, which leads to the formation of angular and square-edged particles and so causes the destroying of the particles within the material bed under higher pressure, can be skipped in the manufacturing of the electrode.

### RELATED ART DOCUMENT

### Patent Document

Patent Document 1: JP 2010-505732 A

### SUMMARY

Meanwhile, when calcination of the mixture of lithium carbonate and a component containing Ni is performed instead of heating the precursor mixture as in Patent Document 1 so as to produce a layer-structured lithium composite compound with high Ni concentration, in which the atomic ratio (Ni/M′) of Ni in M′ in the chemical formula of LiM′O₂ (M′ denotes a metal element containing Ni) is 0.7 or more, for example, the following problems happen. In order to mass-produce a lithium composite oxide with high Ni concentration industrially, a synthesis reaction has to be progressed in large quantity and uniformly. It was found that, however, when the mixture of lithium carbonate and a compound containing Ni is heated, large quantity of carbon dioxide is generated from the lithium carbonate, which inhibits the uniform synthesis reaction in large quantity. This is because carbon dioxide generated leads to a decrease in oxygen partial pressure and inhibits a reaction to oxide Ni so as to change the valence from divalence to trivalence. It was found that, especially in the case of a lithium composite compound with high Ni concentration, if the oxidation of Ni is insufficient, then problems occur, such as a great decrease in capacity.

In view of these problems, the present invention aims to provide a method for manufacturing a cathode electrode material, including the step of performing calcination of the mixture of lithium carbonate and a compound containing Ni, and capable of mass-producing a cathode electrode material including a lithium composite oxide with high Ni concentration industrially.

In order to fulfill the aim, a method for manufacturing a cathode electrode material of the present invention is to manufacture a cathode electrode material used for a cathode of a lithium-ion secondary battery, and includes: a mixture step of mixing lithium carbonate and a compound including each of metal elements other than Li in the following formula (1); and a calcination step of performing calcination of a mixture obtained in the mixture step under oxidizing atmosphere to obtain a lithium composite compound represented by the following formula (1). The calcination step includes: a first heat treatment step of performing heat treatment of the mixture at a heat treatment temperature of 200° C. or more and 400° C. or less for 0.5 hour or more and 5 hours or less so as to obtain a first precursor; a second heat treatment step of performing heat treatment of the first precursor at a heat treatment temperature of 450° C. or more and less than 700° C. for 2 hours or more and 50 hours or less so as to obtain a second precursor; and a third heat treatment step of performing heat treatment of the second precursor at a heat treatment temperature of 700° C. or more and 850° C. or less for 2 hours or more and 50 hours or less so as to obtain the lithium composite compound. In the second heat treatment step and the third heat treatment step, oxidizing atmosphere has oxygen concentration of 80% or more.

Li₁₊ₐNi_{b}Mn_{c}Co_{d}MeO_{2+α} (1).

In the formula (1), M denotes at least one type of element selected from the group consisting of Mg, Al, Ti, Zr, Mo, and Nb, and a, b, c, d, e and α are numerals satisfying −0.1≦a≦0.2, 0.7≦b≦0.9, 0≦c≦0.30, 0.05≦d≦3.30, 0≦e≦0.30, b+c+d+e=1, and −0.1≦α≦0.1.

According to the present invention, a cathode electrode material including a layer-structured lithium composite oxide with high Ni concentration can be mass-produced industrially.

### BRIEF DESCRIPTION OF THE DRAWINGS

FIG. 1A is a flowchart illustrating one embodiment of the method for manufacturing a cathode electrode material of the present invention.

FIG. 1B is a flowchart illustrating a modified example of the method for manufacturing a cathode electrode material in FIG. 1A.

FIG. 2 is a schematic partial cross-sectional view of one embodiment of a lithium-ion secondary battery provided with a cathode including a cathode electrode material.

### DETAILED DESCRIPTION OF THE EMBODIMENTS

The following describes embodiments of a method for manufacturing a cathode electrode material of the present invention in details.

A method for manufacturing a cathode electrode material of the present embodiment is to manufacture a cathode electrode material used for a cathode of a non-aqueous secondary battery, such as a lithium-ion secondary battery. Firstly, a cathode electrode material manufactured by the method for manufacturing a cathode electrode material of the present embodiment is described below in details.

### (Cathode Electrode Material)

A cathode electrode material manufactured by the manufacturing method of the present embodiment is lithium composite compound powder with high Ni concentration having an α-NaFeO₂ type layered structure and represented by the following formula (1):

Li₁₊ₐNi_{b}Mn_{c}Co_{d}MeO_{2+α} (1),

where in formula (1), M denotes at least one type of element selected from the group consisting of Mg, Al, Ti, Zr, Mo, and Nb, and a, b, c, d, e and α are numerals satisfying −0.1≦a≦0.3, 0.7≦b≦0.9, 0≦c≦0.30, 0.05≦d≦0.30, 0≦e≦0.30, b+c+d+e=1, and −0.1≦α≦0.1.

The cathode electrode material including lithium composite compound powder having an α-NaFeO₂ type layered structure and represented by the formula (1) is able to repeat reversible insertion and desorption of lithium ions during charge/discharge, and is a layered cathode electrode material with low resistance. Herein, the particles of the lithium composite compound making up the cathode electrode material may be primary particles, in which individual particles are separated, may be secondary particles including a plurality of primary particles that are coupled by sintering or the like, or may be primary particles or secondary particles including free lithium compounds.

Primary particles of the cathode electrode material preferably have an average particle diameter of 0.1 μm or more and 2 μm or less, for example. Such an average particle diameter of primary particles of the cathode electrode material that is 2 μm or less can improve the fillability of the cathode electrode material at the cathode during the manufacturing of the cathode including the cathode electrode material, and so the cathode with high energy density can be manufactured. Secondary particles of the cathode electrode material preferably have an average particle diameter of 3 μm or more and 50 μm or less, for example.

For the particles of the cathode electrode material, primary particles manufactured by the manufacturing method of a cathode electrode material described later may be granulated by dry granulation or wet granulation so as to be secondary particles. Exemplary means for granulation includes a granulator, such as a spray drier or a tumbling fluidized bed granulator.

In the formula (1), a denotes a stoichiometric ratio of the cathode electrode material represented by the chemical formula of LiM′O₂, i.e., the amount of excess and deficiency of Li with reference to Li:M′:O=1:1:2. Herein, M′ denotes a metal element other than Li in the formula (1). Higher content of Li means a larger number of valence of transition metal before charging and so means a decrease in change of the valence of the transition metal during Li desorption, which therefore can improve the charge/discharge cycle characteristics of the cathode electrode material. On the contrary, higher content of Li leads to a decrease in charge/discharge capacity of the cathode electrode material. Therefore, the range of a indicating the amount of excess and deficiency of Li in the formula (1) may be −0.1 or more and 0.2 or less, whereby the charge/discharge cycle characteristics of the cathode electrode material can be improved and a decrease in charge/discharge capacity thereof can be suppressed.

Preferably the range of a indicating the amount of excess and deficiency of Li in the formula (1) can be −0.05 or more and 0.1 or less. The range of a in the formula (1) that is −0.05 or more leads to a sufficient amount of Li that can contribute to charge/discharge, and so can achieve high capacity of the cathode electrode material. The range of a in the formula (1) that is 0.1 or less leads to sufficient charge compensation by the change of valence of transition metal, and so can achieve high capacity and high charge/discharge cycle characteristics at the same time.

Further, the range of b indicating the content of Ni in the formula (1) that is 0.7 or more can lead to a sufficient amount of Ni in the cathode electrode material that can contribute to charge/discharge, and so can achieve higher capacity of the cathode electrode material. On the contrary, if b in the formula (1) exceeds 0.9, a part of Ni is replaced with Li site, and so the sufficient amount of Li that can contribute to charge/discharge cannot be obtained, which may degrade the charge/discharge capacity of the cathode electrode material. Therefore, the range of b indicating the content of Ni in the formula (1) is 0.7 or more and 0.9 or less, preferably 0.75 or more and 0.85 or less, whereby the cathode electrode material can have higher capacity, and a decrease in charge/discharge capacity thereof can be suppressed.

Adding of Mn has the effect to keep the stable layer structure in spite of Li desorption during charging. However, if c indicating the content of Mn in the formula (1) exceeds 0.30, the capacity of the cathode electrode material decreases. Therefore c in the formula (1) is in the range of 0 or more and 0.30 or less, whereby the layer structure of the cathode electrode material can be kept stably in spite of insertion/desorption of Li due to charge/discharge, and a decrease in capacity of the cathode electrode material can be suppressed.

Further, the range of d indicating the content of Co in the formula (1) that is 0.05 or more can keep the layer structure of the cathode electrode material stably. Such a stably kept layer structure can suppress cation mixing such that Ni is mixed in the Li site, and so excellent charge/discharge cycle characteristics can be obtained. On the contrary, if d in the formula (1) exceeds 0.3, the ratio of Co. which is a material whose supply is limited and so the cost is high, increases relatively, which becomes disadvantage for the industrial production of the cathode electrode material. Therefore d indicating the content of Co in the formula (1) is in the range of 0.05 or more and 0.3 or less, and preferably 0.1 or more and 0.2 or less, whereby charge/discharge cycle characteristics of the cathode electrode material can be improved, and the cathode electrode material can be manufactured favorably in terms of the industrial mass-production.

Further M in the formula (1) is at least one type of metal element selected from the group consisting of Mg, Al, Ti, Zr, Mo, and Nb, whereby sufficient electrochemical activity of the cathode electrode material can be obtained. Then metal site of the cathode electrode material may be replaced with these metal elements, whereby stability of the crystal structure of the cathode electrode material and the electrochemical characteristics (cycle characteristics, for example) of the layered cathode electrode material can be improved. If e indicating the content of M in the formula (1) exceeds 0.30, the capacity of the cathode electrode material decreases. Therefore, the range of e in the formula (1) is 0 or more and 0.30 or less, whereby a decrease in capacity of the cathode electrode material can be suppressed.

The range of α in the formula (1) indicates the range of permitting a layer-structured compound which belongs to the space group R-3m, and so indicates the amount of excess and deficiency of oxygen. From the viewpoint of keeping the α-NaFeO₂ type layered structure of the cathode electrode material, the range is preferably −0.1 or more and 0.1 or less, for example.

The crystal structure of particles of the cathode electrode material can be examined by X-ray diffraction (XRD), for example. The average composition of particles of the cathode electrode material can be examined by Inductively Coupled Plasma (ICP) or Atomic Absorption Spectrometry (AAS), for example.

Particles of the cathode electrode material preferably have a BET specific surface area of about 0.2 m²/g or more and 2.0 m²/g or less. Such a BET specific surface area of about 2.0 m²/g or less of the particles of the cathode electrode material can improve the fillability of the cathode electrode material at the cathode, and so the cathode with high energy density can be manufactured. Herein, the BET specific surface area can be measured by an automatic surface area measuring apparatus.

The cathode electrode material preferably has fracture strength of the particles that is 50 MPa or more and 100 MPa or less. This can prevent the fracture of particles of the cathode electrode material during the manufacturing process of the electrode, and when a cathode mixture layer is formed by applying slurry including the cathode electrode material to the surface of a cathode collector, an error in application, such as peeling-off, can be suppressed. The fracture strength of particles of the cathode electrode material can be measured by a micro-compression tester, for example.

### (Method for Manufacturing Cathode Electrode Material)

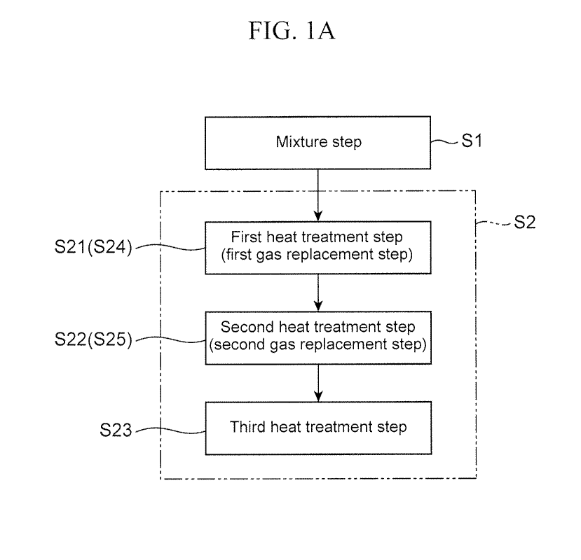

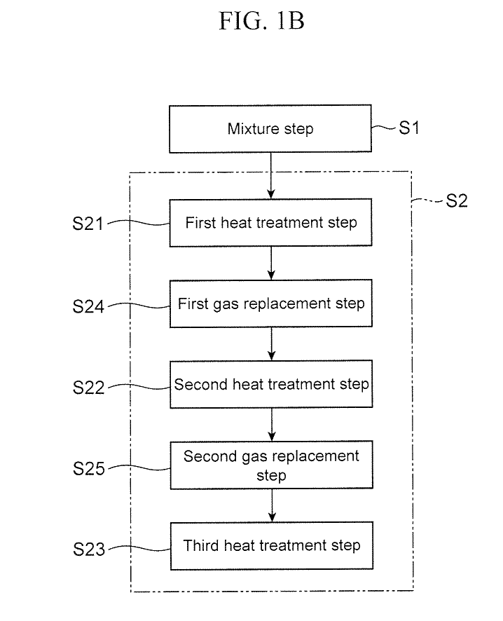

Next, the following describes a method for manufacturing a cathode electrode material of the present embodiment to manufacture the cathode electrode material as stated above. FIG. 1A is a flowchart illustrating the steps included in the method for manufacturing a cathode electrode material of the present embodiment. FIG. 1B is a flowchart illustrating the steps in a modified example of the method for manufacturing a cathode electrode material of the present embodiment in FIG. 1A.

The method for manufacturing a cathode electrode material of the present embodiment includes: a mixture step S1 of mixing lithium carbonate with a compound containing metal elements other than Li in the formula (1); and a calcination step S2 of performing calcination of the mixture prepared at the mixture step S1 under oxidizing atmosphere to prepare a lithium composite compound represented by the formula (1).

In the mixture step S1, a compound containing metal elements other than Li in the formula (1), e.g., a Ni-containing compound, a Mn-containing compound, a Co-containing compound, a M-containing compound and the like may be used, in addition to lithium carbonate, as the starting materials of the cathode electrode material. Herein, the M-containing compound is a compound containing at least one type of metal element selected from the group consisting of Mg, Al, Ti, Zr, Mo, and Nb.

In the mixture step S1, the starting materials that are weighed to have a ratio as a predetermined element composition corresponding to the formula (1) are mixed so as to prepare raw-material powder. In the method for manufacturing a cathode electrode material of the present embodiment, lithium carbonate is used as a starting material containing Li. Lithium carbonate is excellent in industrial availability and practicality as compared with other Li-containing compounds, such as lithium acetate, lithium nitrate, lithium hydroxide, lithium chloride and lithium sulfate.

The Ni-containing compound, the Mn-containing compound, and the Co-containing compound as the starting materials of the cathode electrode material are available in the form of oxides, hydroxides, carbonates, sulfates, or acetates, for example, among which oxides, hydroxides or carbonates are used preferably. The M-containing compound is available in the form of acetates, nitrates, carbonates, sulfates, oxides, or hydroxides, for example, among which carbonates, oxides or hydroxides are used preferably.

In the mixture step S1, these starting materials are preferably pulverized by a pulverizer, for example, before mixing. This allows a solid mixture powder in which the materials can be mixed uniformly to be prepared. Typical micro-pulverizers, such as ball mill, jet mill and sand mill, can be used as a pulverizer to pulverize the compounds as the starting materials. Pulverizing of the starting materials is performed in the wet manner preferably. From the industrial viewpoint, solvent used for wet pulverization is preferably water. The particle size of the pulverized powder of the starting materials in the mixture step S1 becomes the index that is representative of the degree of mixture of the starting materials.

The practical particle size of the starting materials that is industrially available, i.e., the particle size measured with reference to the volume (cumulative distribution) is 1 μm or more for D50 that is the average particle diameter and 10 μm or more for D100 that is the maximum particle diameter. In this case, the pulverized powder of the starting materials measured with reference to the volume preferably has the particle size of 0.3 μm or less for D50 and 1.0 μm or less for D100. In this way, D50 that is 0.3 μm or less leads to sufficient pulverization of the starting materials and uniform mixture. D100 that is 1.0 μm or less can make the composition more uniform and can promote crystallization in the following calcination step S2. The distribution of particle size with reference to the volume can be measured by a laser diffraction particle size analyzer. Since the starting materials are pulverized in the wet manner, such a preferable distribution of the particle size can be easily achieved.

In the mixture step S1, the solid/liquid mixture obtained by pulverization of the starting materials in the wet manner can be dried by a drier, for example. A spray drier, a fluidized-bed drier and an evaporator can be used for the drier, for example. Especially preferably the solid/liquid mixture is dried by a spray drier so as to obtain the mixture powder that is granulated and dried to have 10 μm or more and 30 μm or less for D50. When the mixture powder has D50 of 10 μm or more, then the cathode electrode material also can have D50 of 10 μm or more, which can prevent the cathode layer from peeling off from the collecting foil during formation of the electrode from the cathode electrode material. When the mixture powder has D50 of 30 μm or less, then filling of the cathode electrode material at the electrode in the thickness direction can be made uniform, and so a reduction of the conductive path can be prevented. In order to satisfy the preferable range of D50 for the mixture powder, a rotary-disk type spray drier is suitable.

The mixture powder obtained by the mixture step S1 preferably has bulk specific gravity of 0.6 g/cc or more and 0.8 g/cc or less. Such bulk specific gravity of 0.6 g/cc or more enables the mixture powder with less fine powder, which can prevent the cathode layer from peeling off from the collecting foil during formation of the electrode. Bulk specific gravity of 0.8 g/cc or less can keep the space between particles, and so when the mixture powder is loaded in a vessel for heating in the calcination step S2, oxidizing atmosphere gas can easily pass through the mixture powder.

In the calcination step S2, calcination is performed to the mixture obtained in the mixture step S1 under oxidizing atmosphere to produce the cathode electrode material that is lithium composite compound powder represented by the formula (1). The calcination step S2 of the present embodiment includes a first heat treatment step S21, a second heat treatment step S22 and a third heat treatment step S23.

In the first heat treatment step S21, the mixture obtained in the mixture step S1 is heat treated at the heat treatment temperature of 200° C. or more and 400° C. or less for 0.5 hour or more and 5 hours or less, whereby a first precursor is obtained. The first heat treatment step S21 is performed mainly to remove vaporing components, which inhibits a synthesis reaction of the cathode electrode material, from the mixture obtained in the mixture step S1. That is, the first heat treatment step S21 is a heat treatment step to remove vaporing components in the mixture.

In the first heat treatment step S21, vaporing components contained in the mixture to be heat treated, such as water, impurities, volatile substances associated with thermal decomposition, are vaporized, burned, or volatilized to generate gas. When the mixture contains carbonates, such as lithium carbonate, carbon dioxide is generated in association with thermal decomposition of the carbonate.

In the first heat treatment step S21, if the heat treatment temperature is less than 200° C., the combustion reaction of impurities and the thermal decomposition reaction of the starting materials may be insufficient. In the first heat treatment step S21, if the heat treatment temperature exceeds 400° C., a layered structure of the lithium composite compound may be formed under atmosphere containing gas generated from the mixture during the heat treatment. Therefore, the mixture is heat treated at the temperature of 200° C. or more and 400° C. or less in the first heat treatment step S21, whereby vaporing components can be removed sufficiently and a first precursor that does not include a layer structure can be obtained.

In the first heat treatment step S21, the heat treatment temperature is preferably at 250° C. or more and 400° C. or less, and more preferably at 250° C. or more and 380° C. or less. Such a temperature range can improve the effect to remove vaporing components and the effect to suppress the formation of a layer structure. The heat treatment time can be changed as needed in accordance with the heat treatment temperature, the degree to remove vaporing components, the degree to suppress the formation of a layer structure, and the like.

In the first heat treatment step S21, heat treatment is performed preferably under the flow of atmosphere gas or under the evacuation by a pump so as to exhaust gas generated from the mixture. The flow rate of atmosphere gas per minute or the rate of evacuation by a pump per minute is preferably more than the volume of gas generated from the mixture. The volume of gas generated from the mixture can be calculated based on the mass of the starting materials contained in the mixture and the ratio of the vaporing components, for example.

The first heat treatment step S21 may be performed under reduced pressure that is atmospheric pressure or lower. Since the major purpose of the first heat treatment step S21 is not an oxidizing reaction, the oxidizing atmosphere of the first heat treatment step S21 may be air. When air is used as the oxidizing atmosphere of the first heat treatment step S21, the structure of the heat treatment apparatus can be simplified and the atmosphere can be supplied easily, whereby the productivity of the cathode electrode material can be improved and the manufacturing cost can be reduced. The atmosphere of heat treatment in the first heat treatment step S21 is not limited to the oxidizing atmosphere, which may be non-oxidizing atmosphere, such as inert gas.

In the calcination step S2, following the completion of the first heat treatment step S21, the second heat treatment step S22 is performed. As illustrated in FIG. 1A, during the first heat treatment step S21, a first gas replacement step S24 to replace the oxidizing atmosphere may be performed. Alternatively as illustrated in FIG. 1B, after the completion of the first heat treatment step S21, the first gas replacement step S24 may be performed. In this first gas replacement step S24, the oxidizing atmosphere used in the first heat treatment step S21 is exhausted, and another oxidizing atmosphere is introduced to perform the second heat treatment. Such a first gas replacement step S24 can prevent gas generated from the mixture of the starting materials during the heat treatment of the first heat treatment step S21 from affecting the second heat treatment step S22.

In the first gas replacement step S24, the first precursor may be taken out from the heat treatment device once, and then may be placed in the heat treatment device again. In this case, when taking out the first precursor from the heat treatment device, the oxidizing atmosphere used in the first heat treatment step S21 may be exhausted, and another oxidizing atmosphere may be introduced to the same or another heat treatment device together with the first precursor to perform the second heat treatment step S22.

When evacuation is performed during the heat treatment in the first heat treatment step S21 or after the heat treatment, the first heat treatment step S21, the first gas replacement step S24, and the second heat treatment step S22 may be performed consecutively. In this case, in the first gas replacement step S24, the oxidizing atmosphere may be replaced continuously in the same heat treatment device without taking out the first precursor from the heat treatment device.

In the second heat treatment step S22, the first precursor obtained in the first heat treatment step S21 is heat treated at the heat treatment temperature of 450° C. or more and less than 700° C. for 2 hours or more and 50 hours or less, whereby a second precursor is obtained. The second heat treatment step S22 is performed mainly to oxidize Ni in the first precursor from divalence to trivalence, and to synthesize a layer-structured compound represented by the composition formula of LiM′O₂. That is, the second heat treatment step S22 is a heat treatment step to perform a Ni oxidizing reaction in the first precursor and form a layer structure.

In order to allow the cathode electrode material with high Ni concentration, in which the range of b indicating the content of Ni in the formula (1) is 0.7 or more and 0.9 or less, to have high capacity, the valence of Ni has to be changed by oxidization from divalence to trivalence in the calcination step S2. Divalent Ni easily occupies Li site in the layer-structured LiM′O₂, which becomes a factor to decrease the capacity of the cathode electrode material. To avoid this, in the calcination step S2, calcination of the mixture is performed under the oxidizing atmosphere to change the valence of Ni from divalence to trivalence.

In order to synthesize a layer-structured compound represented by the composition formula LiM′O₂, the first precursor has to react with oxygen in the atmosphere. The reaction to obtain LiNiO₂ by synthesis from lithium oxide and nickel oxide contained in the first precursor can be represented by the following formula (2):

Li₂O+2NiO+(½)O₂→2LiNiO₂ (2).

In order to promote a Ni oxidizing reaction and the reaction of the formula (2), the atmosphere for heat treatment in the second heat treatment step S22 is oxidizing atmosphere containing oxygen, where the oxygen concentration is preferably 80% or more, the oxygen concentration is more preferably 90% or more, the oxygen concentration is still more preferably 95% or more, and the oxygen concentration is further preferably 100%. In order to progress the Ni oxidizing reaction and the reaction of the formula (2) successively, oxygen is preferably supplied continuously during the heat treatment in the second heat treatment step S22, and the heat treatment is preferably performed under the flow of oxidizing atmosphere gas.

In the second heat treatment step S22, the first precursor from which the vaporing components in the mixture of the starting materials have been removed in the first heat treatment step S21 is heat treated, whereby gas, such as carbon dioxide, generated from the first precursor can be suppressed during the heat treatment, and so a decrease in oxygen concentration in the oxidizing atmosphere can be suppressed. As a result, a Ni oxidizing reaction of the first precursor can proceed smoothly in the second heat treatment step S22, whereby the second precursor, in which the reaction to form the lithium composite compound can proceed uniformly, can be obtained. Further, the residue resulting from the starting materials also can be reduced sufficiently.

If the heat treatment temperature in the second heat treatment step S22 is less than 450° C., the reaction to form a layer structure during the formation of the layer-structured second precursor by heat treatment of the first precursor will be delayed remarkably. If the heat treatment temperature in the second heat treatment step S22 is 700° C. or more, grain growth proceeds during the formation of the layer-structured second precursor by heat treatment of the first precursor, and so a reaction with oxygen becomes insufficient.

Therefore, the heat treatment temperature in the second heat treatment step S22 is set at 450° C. or more and less than 700° C., whereby the reaction to form a layer structure can be promoted during the formation of the layer-structured second precursor by heat treatment of the first precursor, and growth of crystal grains can be suppressed so as to suppress insufficient reaction with oxygen. Herein, the heat treatment temperature in the second heat treatment step S22 is set at 450° C. or more and 660° C. or less, whereby the effect to suppress the growth of crystal grains can be improved more.

Further, in order to allow the first precursor to react with oxygen sufficiently within the temperature range of the heat treatment in the second heat treatment step S22, the time of the heat treatment can be set for 2 hours or more and 100 hours or less. From the viewpoint to improve the productivity, it is preferable to set the time of the heat treatment in the second heat treatment step S22 at 2 hours or more and 50 hours or less, and it is more preferable to set it at 2 hours or more and 15 hours or less.

In the calcination step S2, following the completion of the second heat treatment step S22, the third heat treatment step S23 is performed. As illustrated in FIG. 1A, during the second heat treatment step S22, a second gas replacement step S25 to replace the oxidizing atmosphere may be performed. Alternatively as illustrated in FIG. 1B, after the completion of the second heat treatment step S22, the second gas replacement step S25 may be performed. In this second gas replacement step S25, the oxidizing atmosphere used in the second heat treatment step S22 is exhausted, and another oxidizing atmosphere is introduced to perform the third heat treatment. This can prevent gas generated from the first precursor during the heat treatment of the second heat treatment step S22 from affecting the third heat treatment step S23.

In the second gas replacement step S25, the second precursor may be taken out from the heat treatment device once, and then may be placed in the heat treatment device again. In this case, when taking out the second precursor from the heat treatment device, the oxidizing atmosphere used in the second heat treatment step S22 may be exhausted, and another oxidizing atmosphere may be introduced to the same or another heat treatment device together with the second precursor to perform the third heat treatment step S23. Since vaporing components of the mixture of the starting materials have been removed in the first heat treatment step, the second heat treatment step S22 and the third heat treatment step S23 may be performed consecutively without performing the second gas replacement step S25 and taking out the second precursor from the heat treatment device.

In the third heat treatment step S23, the second precursor obtained in the second heat treatment step S22 is heat treated at the temperature of 700° C. or more and 850° C. or less, whereby a cathode electrode material including the lithium composite compound is obtained. The third heat treatment step S23 is performed mainly to progress a Ni oxidizing reaction to oxidize Ni in the second precursor from divalence to trivalence sufficiently and to grow crystal grains so as to allow the cathode electrode material including the lithium composite compound obtained by the heat treatment to exert electrode performance. That is, the third heat treatment step S23 is a heat treatment step to perform a Ni oxidizing reaction in the second precursor and grow crystal grains.

In order to progress a Ni oxidizing reaction sufficiently, the atmosphere for the heat treatment in the third heat treatment step S23 is oxidizing atmosphere containing oxygen, where the oxygen concentration is preferably 80% or more, the oxygen concentration is more preferably 90% or more, the oxygen concentration is still more preferably 95% or more, and the oxygen concentration is further preferably 100%.

If the heat treatment temperature in the third heat treatment step S23 is less than 700° C., the crystallization of the second precursor is insufficient, and if the temperature exceeds 850° C., the layer structure of the second precursor is broken down, so that divalent Ni is generated and the capacity of the cathode electrode material obtained deteriorates. Therefore, the heat treatment temperature in the third heat treatment step S23 is set at the temperature of 700° C. or more and 850° C. or less, whereby grain growth of the second precursor is promoted and breaking-down of the layer structure is suppressed, and so the capacity of the cathode electrode material obtained can be improved. Herein the heat treatment temperature in the third heat treatment step S23 is set at the temperature of 700° C. or more and 840° C. or less, whereby the effect to promote grain growth and the effect to suppress breaking-down of the layer structure can be improved more.

In the third heat treatment step S23, if the oxygen partial pressure is low, heat is required to promote the Ni oxidizing reaction. Therefore if the amount of oxygen supplied to the second precursor is insufficient, the heat treatment temperature has to be increased. Then if the heat treatment temperature is increased, breaking-down of the layer structure cannot be avoided, and so favorable electrode characteristics cannot be achieved for the cathode electrode material obtained. Therefore in order to supply the sufficient amount of oxygen to the second precursor, the time of the heat treatment in the third heat treatment step S23 may be 2 hours or more and 100 hours or less. From the viewpoint of improving the productivity of the cathode electrode material, the time of the heat treatment in the third heat treatment step S23 is preferably 2 hours or more and 50 hours or less, and is more preferably 2 hours or more and 15 hours or less.

As described above, the method for manufacturing a cathode electrode material of the present embodiment includes the first heat treatment step S21 in the calcination step S2 to perform calcination of the mixture obtained in the mixture step S1 under oxidizing atmosphere, in which enough carbon oxide is generated from the mixture, and so the first precursor with suppressed generation of carbon dioxide by heating can be obtained. Then in the second heat treatment step S22 in the calcination step S2, generation of carbon oxide from the first precursor can be suppressed, whereby a decrease in oxygen partial pressure in the oxidizing atmosphere can be suppressed, and so a Ni oxidizing reaction of the first precursor can be promoted to be in a large amount and uniformly, and whereby a second precursor can be obtained. Further in the third heat treatment step S23 of the calcination step S2 as well, generation of carbon oxide from the second precursor can be suppressed, whereby a decrease in oxygen partial pressure in the oxidizing atmosphere can be suppressed, and so a Ni oxidizing reaction of the second precursor can be promoted to be in a large amount and uniformly, and growth of crystal grains can be progressed. Therefore the cathode electrode material obtained can have high capacity and excellent capacity retention, where the material has a layer structure, has high Ni concentration, and has a decreased amount of divalent Ni remaining in the lithium composite compound.

The advantageous effects from the method for manufacturing a cathode electrode material of the present embodiment become remarkable when the weight of the cathode electrode material manufactured is a large amount of a few hundreds grams or more, for example. The reason is as follows. That is, when the weight of the material manufactured is a few grams, influences from gas generated from the starting materials in the calcination step S2 are less. However, in the case where a cathode electrode material is mass-produced on an industrial scale, the volume of gas generated from the starting materials in the calcination step S2 is large, and so oxygen partial pressure in the oxidizing atmosphere in the heat treatment step easily decreases.

Note here that, in the calcination step S2, if the first heat treatment step S21 is skipped, oxygen partial pressure will decrease in the second heat treatment step S22 and the third heat treatment step S23. As a result, heat treatment at a high temperature is required so as to progress a reaction to form a layer structure associated with oxidization of Ni sufficiently, meaning that the temperature exceeds a preferable range. If the second heat treatment step S22 is skipped, it is not preferable because grain growth proceeds in the state where the Ni oxidizing reaction is insufficient. If the third heat treatment step S23 is skipped, appropriate electrode characteristics cannot be obtained.

### (Cathode and Lithium-Ion Secondary Battery)

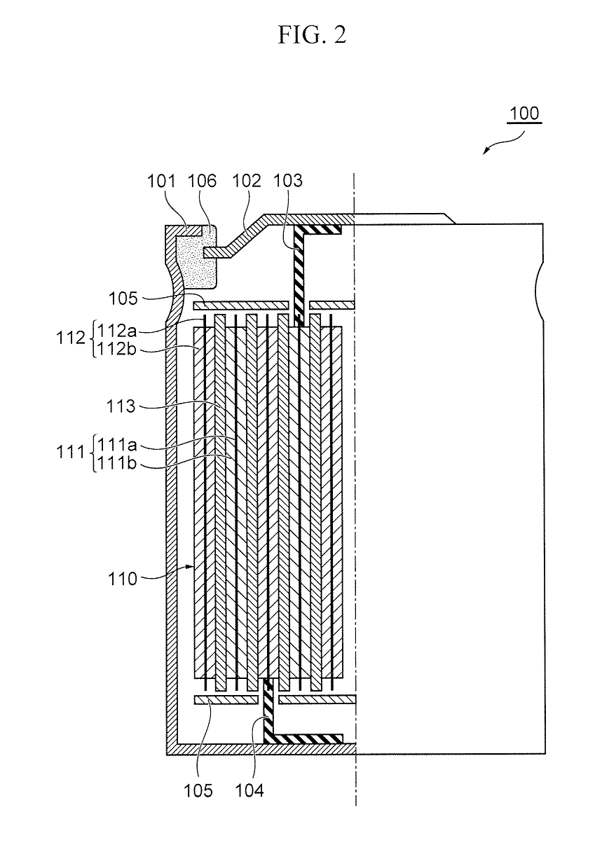

The following describes the structure of a cathode for non-aqueous secondary battery including the cathode electrode material manufactured by the method for manufacturing a cathode electrode material as stated above, and the structure of a non-aqueous secondary battery including the same. FIG. 2 is a schematic partial cross-sectional view of a cathode 111 according to the present embodiment and a non-aqueous secondary battery 100 including the same.

The non-aqueous secondary battery 100 of the present embodiment is a circular cylindrical lithium-ion secondary battery, for example, and includes a bottomed cylindrical battery case 101 to house non-aqueous electrolysis solution, a wound electrode group 110 to be contained in the battery case 101, and a disk-shaped battery lid 102 to seal at the upper opening of the battery case 101. The battery case 101 and the battery lid 102 are made of a metal material, such as stainless steel or aluminum, and the battery lid 102 is fixed to the battery case 101 by caulking, for example, via a sealing member 106 made of an insulating resin material, whereby the battery case 101 is sealed by the battery lid 102 and they are electrically insulated. The shape of the non-aqueous secondary battery 100 is not limited to a circular cylindrical shape, which may have any shape, such as a rectangular shape, a button-shape, or a laminated sheet shape.

The wound electrode group 110 is prepared by winding long belt-shaped cathode 111 and anode 112 that are opposed via a long belt-shaped separator 113 around a winding central shaft. In the wound electrode group 110, a cathode collector 111a is electrically connected to the battery lid 102 via a cathode lead piece 103, and an anode collector 112a is electrically connected to the bottom of the battery case 101 via an anode lead piece 104. Between the wound electrode group 110 and the battery lid 102 and between the wound electrode group 110 and the bottom of the battery case 101, an insulating plate 105 is disposed so as to prevent short-circuit. The cathode lead piece 103 and the anode lead piece 104 are members to draw out current that are made of materials similar to the cathode collector 111a and the anode collector 112a, respectively, and are jointed to the cathode collector 111a and the anode collector 112a, respectively, by spot welding or by ultrasonic pressure welding, for example.

The cathode 111 of the present embodiment includes the cathode collector 111a, and a cathode mixture layer 111b formed on the surface of the cathode collector 111a. As the cathode collector 111a, metal foil, such as aluminum or aluminum alloy, expand metal, punching metal or the like may be used. The metal foil may have a thickness of about 15 μm or more and 25 μm or less, for example. The cathode mixture layer 111b includes a cathode electrode material manufactured by the method for manufacturing a cathode electrode material as stated above. The cathode mixture layer 111b may include an electrical-conducting member, a binder or the like.

The anode 112 includes the anode collector 112a, and an anode mixture layer 112b formed on the surface of the anode collector 112a. As the anode collector 112a, metal foil, such as copper or copper alloy, nickel or nickel alloy, expand metal, punching metal or the like may be used. The metal foil may have a thickness of about 7 μm or more and 10 μm or less, for example. The anode mixture layer 112b includes an anode electrode material that is used for a typical lithium-ion secondary battery. The anode mixture layer 112b may include an electrical-conducting member, a binder or the like.

As the anode electrode material, one type or more of materials, such as a carbon material, a metal material or a metal oxide material, may be used. Examples of available carbon materials include graphite, such as natural graphite or artificial graphite, carbides such as coke and pitch, amorphous carbon and carbon fiber. Examples of available metal materials include lithium, silicon, tin, aluminum, indium, gallium, magnesium or their alloy, and examples of available metal oxide materials include metal oxides including tin, silicon, lithium or titanium.

As the separator 113, a microporous film or non-woven cloth made of polyolefin-based resin such as polyethylene, polypropylene, polyethylene-polypropylene copolymer, polyamide resin, aramid-resin or the like can be used.

The cathode 111 and the anode 112 can be prepared through a mixture preparation step, a mixture coating step and a forming step, for example. In the mixture preparation step, a cathode electrode material or an anode electrode material are stirred with solution containing an electrical-conducting member and a binder by stirring means, such as a planetary mixer, a dispersion mixer, a rotating and revolving mixer for homogenization to prepare mixture slurry.

As the electrical-conducting member, an electrical-conducting member that is typically used for a lithium-ion secondary battery can be used. Specifically carbon particles, such as graphite powder, acetylene black, furnace black, thermal black, channel black, or carbon fiber can be used as the electrical-conducting member. The amount of the electrical-conducting member used can be about 3 mass % or more and 10 mass % or less with respect to the mass of the mixture as a whole, for example.

As the binder, binder that is typically used for a lithium-ion secondary battery can be used. Specifically polyvinylidene fluoride (PVDF), polytetrafluoroethylene, polyhexafluoropropylene, styrene-butadiene rubber, carboxymethylcellulose, polyacrylonitrile, modified polyacrylonitrile and the like can be used as the binder. The amount of the binder used can be about 2 mass % or more and 10 mass % or less with respect to the mass of the mixture as a whole, for example. The mixture ratio of the anode electrode material and the binder is desirably 95:5 by weight, for example.

The solvent of the solution may be one selected in accordance with the type of the binder from N-methylpyrrolidone, water, N,N-dimethylformamide, N,N-dimethylacetamide, methanol, ethanol, propanol, isopropanol, ethylene glycol, diethylene glycol, glycerin, dimethylsulfoxide, tetrahydrofuran and the like.

In the mixture coating step, firstly mixture slurry containing a cathode electrode material and mixture slurry containing the anode electrode material prepared by the mixture preparation step are coated on the surface of the cathode collector 111a and the anode collector 112a, respectively, by coating means, such as a bar coater, a doctor blade or a roll transfer machine. Next, the cathode collector 111a and the anode collector 112a with their mixture slurry coated thereon are heat treated, so as to vaporize or evaporate the solvent of the solution contained in the mixture slurry for removal. In this way, a cathode mixture layer 111b and an anode mixture layer 112b are formed on the surfaces of the cathode collector 111a and the anode collector 112a, respectively.

In the forming step, firstly, the cathode mixture layer 111b on the surface of the cathode collector 111a and the anode mixture layer 112b on the surface of the anode collector 112a are pressure-formed using pressure means, such as roll pressing. Thereby, the cathode mixture layer 111b can have a thickness of about 100 μm or more and 300 μm or less, for example, and the anode mixture layer 112b can have a thickness of about 20 μm or more and 150 μm or less. Then the cathode collector 111a and the cathode mixture layer 111b, and the anode collector 112a and the anode mixture layer 112b are cut to have a long belt shape, whereby a cathode 111 and an anode 112 can be prepared.

The thus prepared cathode 111 and anode 112 are opposed via the separator 113 and then wound around a winding central shaft to be a wound electrode group 110. For the wound electrode group 110, the anode collector 112a is connected to the bottom of the battery case 101 via the anode lead piece 104 and the cathode collector 111a is connected to the battery lid 102 via the cathode lead piece 103, and then the wound electrode group is housed in the battery case 101, in which short-circuit of the battery case 101 and the battery lid 102 is prevented by the insulating plate 105 or the like. Thereafter, non-aqueous electrolysis solution is poured into the battery case 101, and the battery lid 102 is fixed to the battery case 101 via the sealing member 106 for hermetically sealing of the battery case 101, so that the non-aqueous secondary battery 100 can be manufactured.

The electrolysis solution poured into the battery case 101 is desirably prepared by dissolving lithium hexafluorophosphate (LiPF₆), lithium tetrafluoroborate (LiBF₄), lithium perchlorate (LiClO₄) or the like as the electrolyte in the solvent, such as diethyl carbonate (DEC), dimethyl carbonate (DMC), ethylene carbonate (EC), propylene carbonate (PC), vinylene carbonate (VC), methyl acetate (MA), ethyl methyl carbonate (EMC) or methyl propyl carbonate (MPC). The concentration of the electrolyte is desirably 0.7 M or more and 1.5 M or less. In this electrolysis solution, a component having a carboxylic acid anhydride group, a component having sulfur element, such as propanesultone, or a component having boron may be mixed. These components are added to suppress reductive degradation of the electrolysis solution on the surface of the anode, to prevent reductive precipitation of metal elements, such as manganese eluted from the cathode, on the anode, to improve ion conductive property of the electrolysis solution, to let the electrolysis solution have fire retardancy, and the like, and so they can be selected appropriately depending on the purpose.

The thus configured non-aqueous secondary battery 100 includes the battery lid 102 as a cathode external terminal and the bottom of the battery case 101 as an anode external terminal, and can store electricity supplied externally in the wound electrode group 110, and can supply electricity stored in the wound electrode group 110 to an external device or the like. In this way, the non-aqueous secondary battery 100 of the present embodiment can be used as a small-sized power source used for a portable electronic device, home appliance or the like, a fixed power supply used as an uninterruptible power source or a power leveling device, and a driving power source used for driving of ship, railway, hybrid vehicles and electric vehicles.

The following describes examples based on the method for manufacturing a cathode electrode material of the present invention, and comparative examples manufactured by a method different from the method for manufacturing a cathode electrode material of the present invention.

### Example 1

Firstly, lithium carbonate, nickel hydroxide, cobalt carbonate and manganese carbonate were prepared as the starting materials of the cathode electrode material. Next, these starting materials were weighted so that they have the atomic ratio of Li:Ni:Co:Mn as 1.04:0.80:0.10:0.10, were pulverized by a pulverizer and were mixed in a wet manner to prepare slurry, and the obtained slurry (mixture) was dried by a spray drier (mixture step). Then, calcination of the dried mixture was performed to obtain calcination powder (calcination step).

Specifically beads mill was used as the pulverizer, and wet mixture was performed using water as the solvent. The operation was continued until the particle size became stable. When the particle size of the thus obtained slurry was measured by a laser diffraction particle size analyzer, D50=0.13 μm and D100=0.26 μm. The slurry was dried by a rotary-disk type spray drier, and then the dried mixture powder was obtained, in which D50=17 μm and the bulk specific gravity was 0.74 g/cc.

Next, 1 kg of the mixture (mixture powder) obtained in the mixture step was loaded in an alumina container of 300 mm in length, 300 mm in width and 100 mm in height, to which heat treatment was performed by a continuous conveying furnace at the heat treatment temperature of 350° C. under the air atmosphere for 1 hour (first heat treatment step). In the first heat treatment step, water vapor due to thermal decomposition of nickel hydroxide and carbon dioxide due to thermal decomposition of cobalt carbonate and manganese carbonate were generated. Next, the thus obtained powder (first precursor) was heat treated by a continuous conveying furnace having the atmosphere whose oxygen concentration in the furnace was adjusted to be 90% or more by replacement and in the flow of oxygen at the heat treatment temperature of 600° C. for 10 hours (second heat treatment step). In the second heat treatment step, the remaining cobalt carbonate and manganese carbonate that did not react in the first heat treatment step were thermal-decomposed, and so carbon dioxide was generated therefrom. Lithium carbonate was decomposed and emitted carbon dioxide in order to react with oxides of nickel, cobalt and manganese after thermal decomposition to form a precursor of lithium composite oxide. Further, the thus obtained powder (second precursor) was heat treated by a continuous conveying furnace having the atmosphere whose oxygen concentration in the furnace was adjusted to be 90% or more by replacement and in the flow of oxygen at the heat treatment temperature of 800° C. for 10 hours, so that calcination powder (lithium composite component) was obtained (third heat treatment step). In the third heat treatment step, oxidization of nickel causes a reaction in the formula (2) to proceed, so that lithium carbonate as the reaction residue was decomposed into lithium oxide and carbon dioxide, and carbon dioxide was generated. In order to synthesize lithium composite oxide, it is important that carbon dioxide generated in the second and the third heat treatment steps has to be exhausted rapidly, and that sufficient oxygen is kept to promote the oxidizing reaction.

The thus obtained calcination powder was classified using a sieve having an opening of 53 μm or less, and the resultant was a cathode electrode material. As a result of analysis by ICP about the element ratio of the cathode electrode material, Li:Ni:Mn:Co was 1.02:0.80:0.10:0.10. The measurement by X-ray diffraction showed the diffraction pattern corresponding to an α-NaFeO₂ type layered structure, where the lattice constant was a=0.287 nm and c=1.42 nm. The specific surface area thereof was 0.37 m²/g.

### Example 2

A cathode electrode material was manufactured similarly to Example 1 other than that the temperature of the first heat treatment step was decreased from 350° C. in Example 1 to 250° C.

### Example 3

A cathode electrode material was manufactured similarly to Example I other than that the temperature of the second heat treatment step was increased from 600° C. in Example 1 to 650° C.

### Example 4

A cathode electrode material was manufactured similarly to Example 1 other than that the temperature of the second heat treatment step was decreased from 600° C. in Example 1 to 550° C.

### Example 5

A cathode electrode material was manufactured similarly to Example 1 other than that the temperature of the second heat treatment step was decreased from 600° C. in Example 1 to 500° C.

### Comparative Example 1

A cathode electrode material was manufactured similarly to Example 1 other than that the first heat treatment step was skipped in the calcination step, and measurement by X-ray diffraction and of the specific surface area was performed. The obtained lattice constant was a=0.287 nm and c=1.41 nm. The specific surface area thereof was 0.40 m²/g.

### Comparative Example 2

A cathode electrode material was manufactured similarly to Example 1 other than that the first heat treatment step and the second heat treatment step were skipped in the calcination step, and measurement by X-ray diffraction and of the specific surface area was performed. The obtained lattice constant was a=0.287 nm and c=1.42 nm. The specific surface area thereof was 0.38 m²/g.

### Comparative Example 3

A cathode electrode material was manufactured similarly to Example 1 other than that the temperature of the first heat treatment step was decreased from 350° C. in Example 1 to 150° C.

### Comparative Example 4

A cathode electrode material was manufactured similarly to Example 1 other than that the temperature of the second heat treatment step was increased from 600° C. in Example 1 to 700° C.

### Comparative Example 5

A cathode electrode material was manufactured similarly to Example 1 other than that the temperature of the second heat treatment step was decreased from 600° C. in Example 1 to 400° C.

### Comparative Example 6

A cathode electrode material was manufactured similarly to Example 1 other than that the second heat treatment and the third heat treatment were performed under the air atmosphere instead of the oxidizing atmosphere with the oxygen concentration of 90% or more in Example 1.

### (Manufacturing of a Lithium-Ion Secondary Battery)

Using the cathode electrode materials manufactured from Example 1 to Example 5 and from Comparative Example 1 to Comparative Example 6, lithium-ion secondary batteries as Example 1 to Example 5 and from Comparative Example 1 to Comparative Example 6 were manufactured by the following procedure.

Firstly, a cathode electrode material, a binder, and an electrical-conducting member were mixed to prepare cathode mixture slurry. Then the cathode mixture slurry prepared was coated on aluminum foil of 20 μm in thickness as a cathode collector, and was dried at 120° C., followed by pressure forming by pressing so that the electrode density was 2.0 g/cm³. Then this was stamped to have a disk shape of 15 mm in diameter, so as to prepare a cathode. Then, an anode was prepared by using metal lithium as an anode electrode material.

Next, using the thus prepared cathode, anode and non-aqueous electrolysis solution, a lithium-ion secondary battery was manufactured. For the non-aqueous electrolysis solution, ethylene carbonate and dimethyl carbonate were mixed so that their volume ratio was 3:7 to prepare solvent, into which LiPF₆ was dissolved so that the final concentration was 1.0 mol/L.

Next, for each of the lithium-ion secondary batteries as Example 1 to Example 5 and from Comparative Example 1 to Comparative Example 6, charge-discharge test was performed to measure the first discharge capacity. Charging was performed while setting the charge current at 0.2 CA and with constant current and constant voltage until the charge cutoff voltage of 4.4 V. Discharging was performed while setting the discharge current at 0.2 CA and with constant current until the discharge cutoff voltage of 2.5 V. Then, setting the charge and discharge current at 1.0 CA, the charge cutoff voltage at 4.4 V and the discharge cutoff voltage at 2.5 V, 50-cycle of charge/discharge was repeated. The discharge capacity measured at the 50th cycle was divided by the discharge capacity measured at the first cycle to calculate the resultant value by percentage, which was defined as the capacity retention. Table 1 shows the result.

TABLE 1

| | Heat treatment | | | | | |
|---|---|---|---|---|---|---|
| | temperature (° C.) | | | | | |
| | First | Second | | 0.2 C | 1 C first | |
| | heat | heat | | discharge | discharge | Capacity |
| | treat- | treat- | Third heat | capacity | capacity | retention |
| | ment | ment | treatment | (Ah/kg) | (Ah/kg) | (%) |
| Ex. 1 | 350 | 600 | 800 | 198 | 180 | 81 |
| Ex. 2 | 250 | 600 | 800 | 197 | 178 | 80 |
| Ex. 3 | 350 | 650 | 800 | 199 | 180 | 82 |
| Ex. 4 | 350 | 550 | 800 | 198 | 179 | 81 |
| Ex. 5 | 350 | 500 | 800 | 196 | 177 | 79 |
| Comp. | none | 600 | 800 | 192 | 173 | 71 |
| Ex. 1 | | | | | | |
| Comp. | none | none | 800 | 191 | 172 | 76 |
| Ex. 2 | | | | | | |
| Comp. | 150 | 600 | 800 | 192 | 174 | 70 |
| Ex. 3 | | | | | | |
| Comp. | 350 | 700 | 800 | 193 | 175 | 76 |
| Ex. 4 | | | | | | |
| Comp. | 350 | 400 | 800 | 194 | 175 | 78 |
| Ex. 5 | | | | | | |
| Comp. | 350 | 600 | 800 | 84 | 60 | — |
| Ex. 6 | | | | | | |

From the above result, the lithium-ion secondary battery as Example 1 including the cathode electrode material that was manufactured through the calcination step including the first heat treatment, the second heat treatment and the third heat treatment for the cathode had 0.2C discharge capacity of 198 Ah/kg, the 1 C first discharge of 180 Ah/kg and the capacity retention of 81%, all of which were favorable results. The lithium-ion secondary batteries as Example 2 to Example 5 that were manufactured through the first heat treatment step at the temperature of 250° C. or more and 400° C. or less, the second heat treatment step at the temperature of 450° C. or more and less than 700° C. and the third heat treatment step at the temperature of 700° C. or more and 840° C. or less also showed favorable results similarly.

On the contrary, for the lithium-ion secondary batteries as Comparative Example 1 and Comparative Example 2 including the cathode electrode materials that were manufactured by skipping the first heat treatment in the calcination step and by skipping the first heat treatment and the second heat treatment for the cathodes, the numerical value was decreased from the result of the lithium-ion secondary battery of Example 1. For the lithium-ion secondary battery as Comparative Example 3, in which the temperature of the first heat treatment was decreased to 150° C., the lithium-ion secondary battery as Comparative Example 4, in which the temperature of the second heat treatment was increased to 700° C., and the lithium-ion secondary battery as Comparative Example 5, in which the temperature of the second heat treatment was decreased to 400° C., their numerical values were decreased from the result of Examples. For the lithium-ion secondary battery as Comparative Example 6, in which all of the first heat treatment to the third heat treatment were performed under the air atmosphere, the discharge capacity was decreased greatly. In this way, it was confirmed that cathode electrode materials having high capacity and excellent capacity retention can be obtained by the method for manufacturing a cathode electrode material from Example 1 to Example 5.

### Example 6

Next, a cathode electrode material was prepared similarly to Example 1 other than that the time of the wet mixture in the mixture step was shortened to 50% of Example 1, and a lithium-ion secondary battery as Example 6 was manufactured. When the particle size of the pulverized powder of the starting materials included in the slurry after wet mixture and before drying and granulation in the mixture step was measured by a laser diffraction particle size analyzer, D50=0.18 μm and D100=0.45 μm.

### Example 7

Next, a cathode electrode material was prepared similarly to Example 1 other than that the time of the wet mixture was shortened to 38%, and a lithium-ion secondary battery as Example 7 was manufactured. When the particle size of the pulverized powder of the starting materials included in the slurry after wet mixture that was measured similarly to Example 6 was D50=0.27 μm and D100=1.3 μm.

### Example 8

Next, a cathode electrode material was prepared similarly to Example 1 other than that the time of the wet mixture was shortened to 25%, and a lithium-ion secondary battery as Example 8 was manufactured. When the particle size of the pulverized powder of the starting materials included in the slurry after wet mixture that was measured similarly to Example 6 was D50=0.36 μm and D100=5.1 μm.

Next, for each of the lithium-ion secondary batteries as Example 6, Example 7 and Example 8, charge-discharge test was performed under the condition similar to that for the lithium-ion secondary battery of Example 1 to measure the first discharge capacity, and their capacity retention was calculated. Table 2 shows a comparison among the results of the lithium-ion secondary batteries of Example 1 and Example 6, and the results of the lithium-ion secondary batteries of Example 7 and Example 8.

TABLE 2

| | | | |
|---|---|---|---|
| Particle size | 0.2 C | 1 C first | |
| of mixture | discharge | discharge | Capacity |
| (μm) | capacity | capacity | retention |

| | D50 | D100 | (Ah/kg) | (Ah/kg) | (%) |
|---|---|---|---|---|---|
| Ex. 1 | 0.13 | 0.26 | 198 | 180 | 81 |
| Ex. 6 | 0.18 | 0.45 | 195 | 179 | 84 |
| Ex. 7 | 0.27 | 1.3 | 199 | 184 | 76 |
| Ex. 8 | 0.36 | 5.1 | 196 | 182 | 76 |

The lithium-ion secondary batteries as Example 1 and Example 6 showed relatively high discharge capacity and capacity retention. On the contrary, the lithium-ion secondary batteries as Example 7 and Example 8 showed relatively high discharge capacity similarly to the lithium-ion secondary batteries as Example 1 and Example 6, but their capacity retention after the 50th cycle was decreased, and deterioration due to charge/discharge cycles was found. That is, if the time for mixture in the mixture step is short and so D50 and D100 of the mixture powder increase, then the capacity after the cycles deteriorates.

As stated above, in order to obtain a cathode electrode material having high capacity and excellent capacity retention as in Example 1 and Example 6, it was found that sufficient mixture of the starting materials was required. It was further found that, in the mixture step, the particle size of the pulverized powder of the starting materials before drying and granulation that was measured with reference to the volume was D50 of less than 0.27 μm and D100 of 1.3 μm or less and preferably D50 of less than 0.2 μm and D100 of 1.0 μm or less.

While certain embodiments of the present invention have been described in details with reference to the drawings, the specific configuration is not limited to the above-stated embodiments, and it should be understood that we intend to cover by the present invention design modifications without departing from the spirits of the present invention.

### DESCRIPTION OF SYMBOLS

100 Lithium-ion secondary battery
111 Cathode
S1 Mixture step
S2 Calcination step
S21 First heat treatment step
S22 Second heat treatment step
S23 Third heat treatment step
S24 First gas replacement step
S25 Second gas replacement step

What is claimed is:

1. A method for manufacturing a cathode electrode material used for a cathode of a lithium-ion secondary battery, comprising:
a mixture step of mixing lithium carbonate and a compound including each of metal elements other than Li in the following formula (1); and
a calcination step of performing calcination of a mixture obtained in the mixture step under oxidizing atmosphere to obtain a lithium composite compound represented by the following formula (1), wherein
the calcination step includes:
a first heat treatment step of performing heat treatment of the mixture at a heat treatment temperature of 200° C. or more and 400° C. or less for 0.5 hour or more and 5 hours or less so as to obtain a first precursor;
a second heat treatment step of performing heat treatment of the first precursor at a heat treatment temperature of 450° C. or more and less than 700° C. for 2 hours or more and 50 hours or less so as to obtain a second precursor; and
a third heat treatment step of performing heat treatment of the second precursor at a heat treatment temperature of 700° C. or more and 850° C. or less for 2 hours or more and 50 hours or less so as to obtain the lithium composite compound,
wherein
in the second heat treatment step and the third heat treatment step, oxidizing atmosphere has oxygen concentration of 80% or more,
Li₁₊ₐNi_{b}Mn_{c}Co_{d}MeO_{2+α} (1),
where in the formula (1), M denotes at least one type of element selected from the group consisting of Mg, Al, Ti, Zr, Mo, and Nb, and a, b, c, d, e and α are numerals satisfying −0.1≦a≦0.2, 0.7≦b≦0.9, 0≦c≦0.30, 0.05≦d≦0.30, 0≦e≦0.30, b+c+d+e=1, and −0.1≦α≦0.1.

2. The method for manufacturing a cathode electrode material according to claim 1, wherein
the heat treatment temperature in the first heat treatment step is 250° C. or more and 400° C. or less,
the heat treatment temperature in the second heat treatment step is 450° C. or more and 660° C. or less, and
the heat treatment temperature in the third heat treatment step is 700° C. or more and 840° C. or less.

3. The method for manufacturing a cathode electrode material according to claim 1, wherein
the first heat treatment step is to obtain the first precursor, from which vaporing components included in the mixture have been removed,
the second heat treatment step is to progress a Ni oxidizing reaction to oxidize divalent Ni included in the first precursor to be trivalent Ni to obtain the second precursor, and
the third heat treatment step is to progress the Ni oxidizing reaction of the second precursor and growth of crystal grains to obtain the lithium composite compound.

4. The method for manufacturing a cathode electrode material according to claim 1, further comprising a first gas replacement step to replace the oxidizing atmosphere performed during the first heat treatment step or after the first heat treatment step.

5. The method for manufacturing a cathode electrode material according to claim 4, wherein the first gas replacement step is performed after the first heat treatment step, and in the second heat treatment step, oxidizing atmosphere is newly introduced to perform the heat treatment.

6. The method for manufacturing a cathode electrode material according to claim 1, further comprising a second gas replacement step to replace the oxidizing atmosphere performed during the second heat treatment step or after the second heat treatment step.

7. The method for manufacturing a cathode electrode material according to claim 6, wherein the second gas replacement step is performed after the second heat treatment step, and in the third heat treatment step, oxidizing atmosphere is newly introduced to perform the heat treatment.

8. The method for manufacturing a cathode electrode material according to claim 1, wherein oxidizing atmosphere in the first heat treatment step is air.
